(19) United States
(12) Patent Application Publication
(10) Pub. No.: US 2016/0018091 A1
(43) Pub. Date: Jan. 21, 2016

(54) Illumination Assembly

(71) Applicant: Howard J. Markley, Hedgesville, WV (US)

(72) Inventor: Howard J. Markley, Hedgesville, WV (US)

(21) Appl. No.: 14/335,317

(22) Filed: Jul. 18, 2014

(51) Int. Cl. F21V 21/32; F21V 23/04; F21S 9/02

(52) U.S. Cl. CPC F21V 21/32; F21S 9/02; F21V 23/04

(57) ABSTRACT

An illumination assembly for providing hands free illumination of an area from a selected angle includes a charging head. A neck is coupled to the charging head. The neck is flexible so the neck is positionable at selected position with respect to the charging head. An illuminating head is coupled to the neck. The illuminating head is positionable at selected position with respect to the charging head. A light emitter is coupled to the illuminating head. The light emitter emits light so the light emitter illuminates an area.

### BACKGROUND OF THE DISCLOSURE

### Field of the Disclosure

The disclosure relates to illumination devices and more particularly pertains to a new illumination device for providing hands free illumination of an area from a selected angle.

### SUMMARY OF THE DISCLOSURE

An embodiment of the disclosure meets the needs presented above by generally comprising a charging head. A neck is coupled to the charging head. The neck is flexible so the neck is positionable at selected position with respect to the charging head. An illuminating head is coupled to the neck. The illuminating head is positionable at selected position with respect to the charging head. A light emitter is coupled to the illuminating head. The light emitter emits light so the light emitter illuminates an area.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a illumination assembly according to an embodiment of the disclosure.

FIG. 2 is a back view of an embodiment of the disclosure.

FIG. 3 is a bottom view of an embodiment of the disclosure.

FIG. 4 is a front perspective view of an embodiment of the disclosure.

FIG. 5 is a cross sectional view taken along line 5-5 of FIG. 4 of an embodiment of the disclosure.

### DESCRIPTION OF THE PREFERRED EMBODIMENT

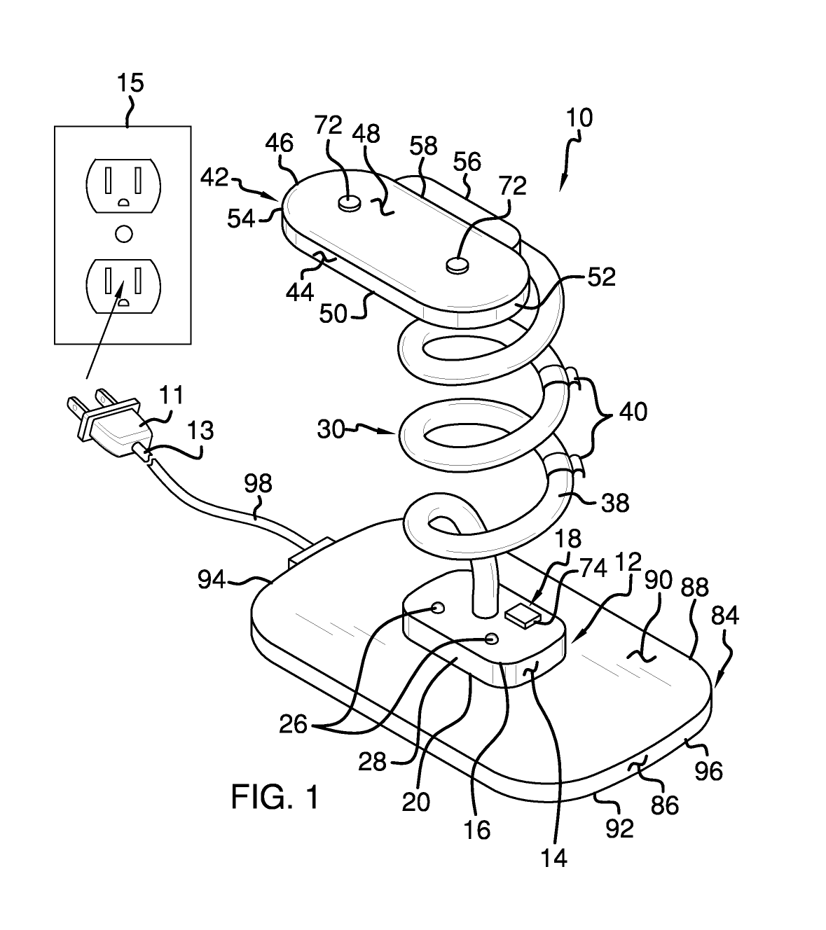

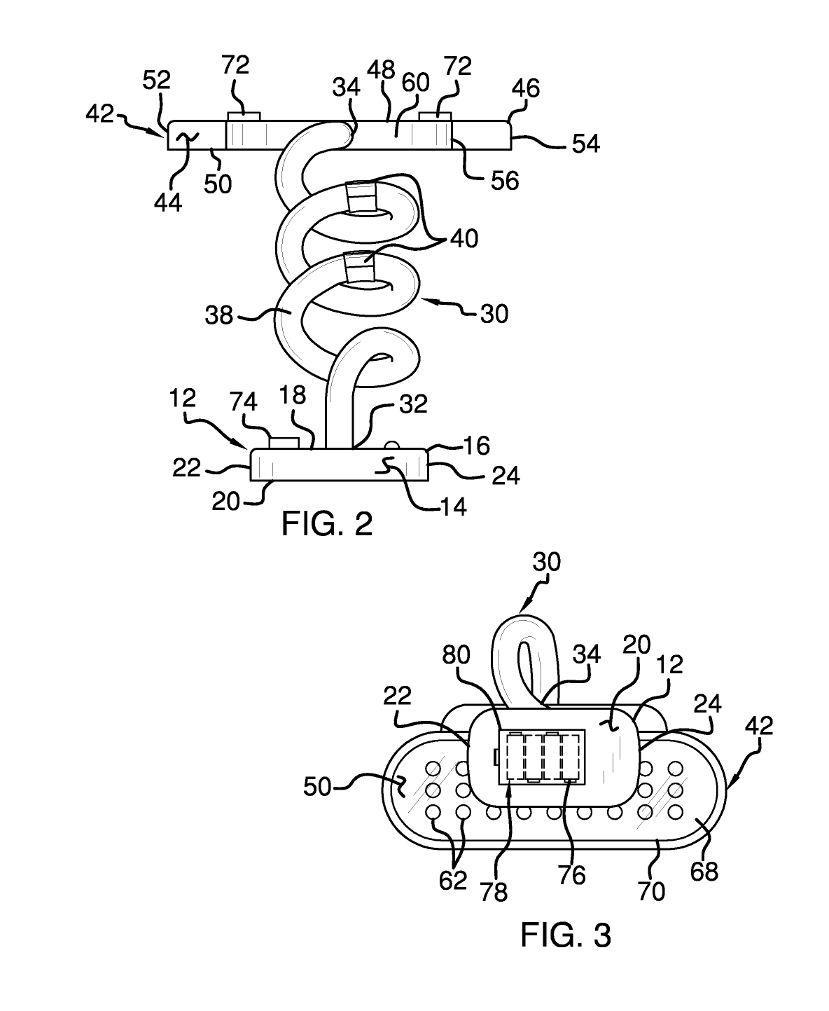

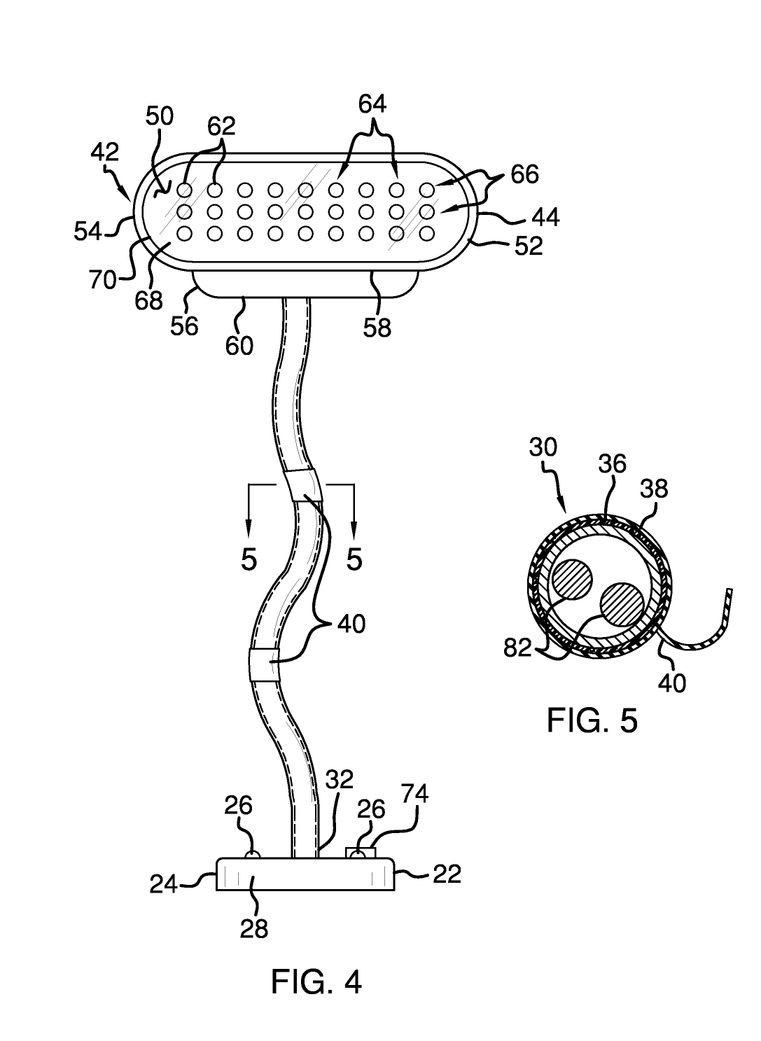

With reference now to the drawings, and in particular to FIGS. 1 through 5 thereof, a new illumination device embodying the principles and concepts of an embodiment of the disclosure and generally designated by the reference numeral 10 will be described.

As best illustrated in FIGS. 1 through 5, the illumination assembly 10 generally comprises a charging head 12. An oblique surface 14 of an outer wall 16 of the charging head 12 extends between a top surface 18 and a bottom surface 20 of the outer wall 16 of the charging head 12. The charging head 12 is elongated between a first end 22 and a second end 24 of the charging head 12. A light emitter 26 is coupled to the charging head 12. The light emitter 26 is one of a pair of the light emitters 26. The pair of light emitters 26 are spaced apart and positioned proximate a forward side 28 of the oblique surface 14 of the outer wall 16 of the charging head 12.

A neck 30 has a bottom end 32 and a top end 34 and the neck 30 is elongated between the top 32 and bottom 34 ends. The bottom end 34 of the neck 30 is coupled to the top surface 18 of the outer wall 16 of the charging head 12. Moreover, the neck 30 is centrally positioned on the charging head 12. An exterior wall 36 of the neck 30 is curvilinear so the neck 30 has a tubular shape. Additionally, the exterior wall 36 of the neck 30 is laterally twisted so the neck 30 forms a helical coil extending between the bottom 32 and top 34 ends of the neck 30. The neck 30 is flexible so the neck 30 is positionable at selected position with respect to the charging head 12. The neck 30 may be comprised of a magnetic material.

A sheath 38 is coupled to the exterior wall 36 of the neck 30. The sheath 38 completely covers the exterior wall 36 of the neck 30. Additionally, the sheath 38 extends between the top 34 and bottom 32 ends of the neck 30. A pair of clips 40 is coupled to the neck 30. Each of the pair of clips 40 are spaced apart from one another. The pair of clips 40 engages the sheath 38.

An illuminating head 42 is provided. A lateral surface 44 of an outermost wall 46 of the illuminating head 42 extends between each of a topmost surface 48 and a bottommost surface 50 of the outermost wall 46 of the illuminating head 42. The illuminating head 42 is elongated between a primary end 52 and a secondary end 54 of the illuminating head 42. Additionally, the primary 52 and secondary 54 ends of the illuminating head 42 are rounded so the illuminating head 42 has an ovoid shape.

A tab 56 extends rearwardly away from a rear side 58 of the lateral surface 44 of the outermost wall 46 of the illuminating head 42. The tab 56 extends between the primary 52 and secondary 54 ends of the illuminating head 42. A rear side 60 of the tab 56 on the illuminating head 42 is coupled to the top end 34 of the neck 30. The illuminating head 42 is positionable at selected position with respect to the charging head 12. Additionally, the illuminating head 42 may be comprised of a flexible and magnetic material. The illuminating head 42 may be bent along a longitudinal axis extending between the primary 52 and secondary 54 ends of the illuminating head 42.

A light emitter 62 is coupled to the bottommost surface 50 of the outermost wall 46 of the illuminating head 42. The light emitter 62 selectively emits a beam of light away from the illuminating head 42. Moreover, the light emitter 62 may be an LED of any conventional design. The light emitter 62 is one of a plurality of the light emitters 62.

The plurality of light emitters 62 is arranged in a plurality of columns 64 and rows 66. The plurality of light emitters 62 is evenly distributed on the bottommost surface 50 of the outermost wall 46 of the illuminating head 42. The plurality of light emitters 62 selectively illuminates an area. The illuminating head 42 is selectively positioned to illuminate the area. Additionally, the plurality of light emitters 62 emits the beam of light into a focused point when the illuminating head 42 is bent along the longitudinal axis.

A window 68 is coupled to the bottommost surface 50 of the outermost wall 46 of the illuminating head 42. An outer edge 70 of the window 68 is coextensive with the outermost wall 46 of the illuminating head 42. Additionally, the outer edge 70 of the window 68 is spaced inwardly from the outermost wall 46 of the illuminating head 42. The window 68 covers the plurality of light emitters 62.

A pair of couplers 72 is coupled to the topmost surface 48 of the outermost wall 46 of the illuminating head 42. The pair of couplers 72 are spaced apart so each of the pair of couplers 72 are positioned proximate an associated one of the primary 52 and secondary 54 ends of the illuminating head 42. Each of the pair of couplers 72 may be comprised of a magnetic material. The pair of couplers 42 magnetically engages a support surface so the illuminating head 42 is retained on the support surface. The support surface may be a wall or other support surface proximate the area to be illuminated.

An actuator 74 is coupled to the top surface 18 of the outer wall 16 of the charging head 12. The actuator 74 is electrically coupled to the plurality of the light emitters 62. The actuator 74 selectively actuates and de-actuates the plurality of light emitters 62. Additionally, the actuator 74 is positioned proximate the first end 22 of the charging head 12.

A power supply 76 is coupled to the charging head 12. The power supply 76 is electrically coupled to the actuator 74. Moreover, the power supply 76 comprises at least one rechargeable battery 78. The power supply 76 is positioned beneath a battery cover 80. The battery cover 80 is removably coupled to the bottom surface 20 of the outer wall 16 of the charging head 12. A pair of conductors 82 is electrically coupled between the power supply 76 and the plurality of light emitters 62. The pair of conductors 82 extends through an interior of the neck 30.

A base 84 is provided. A flanking surface 86 of an extraneous wall 88 of the base 84 extends between a crowning surface 90 and a basal surface 92 of the extraneous wall 88 of the base 84. The base 84 is elongated between a leading end 94 and a following end 96 of the base 84. The base 84 is positionable on a support surface so a basal surface 92 of the extraneous wall 88 of the base 84 abuts the support surface. The support surface may be a table or other similar support surface.

A power cord 98 extends away from the leading end 94 of the base 84. A plug 11 is electrically coupled to free end 13 of the power cord 98. The plug 11 is selectively electrically coupled to a power source 15. The power source 15 may be an electrical outlet of any conventional design. Additionally, the charging head 12 is positionable on the crowning surface 90 of the extraneous wall 88 of the base 84 so the charging head 12 is electrically coupled to the base 84. The base 84 re-charges the power supply 76 in the charging head 12. The pair of light emitters 26 on the charging head 12 are illuminated when the charging head 12 is electrically coupled to the base 84.

In use, the neck 30 is magnetically coupled to the support surface proximate the area to be illuminated so the assembly 10 is retained on the support surface. The illuminating head 42 is freely positionable when the neck 30 is magnetically coupled to the support surface. The assembly 10 provides hands free illumination of the area. Additionally, the pair of couplers on the 72 illuminating head 42 may be magnetically coupled to the support surface proximate the area to be illuminated so the illuminating head 42 is retained at a fixed position on the support surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illumination assembly configured to engage a support surface such that said illumination assembly is retained on the support surface, said illumination assembly providing hands free illumination of an area from a selected angle, said assembly comprising:
a charging head;
a neck coupled to said charging head, said neck being flexible such that said neck is positionable at selected position with respect to said charging head;
an illuminating head coupled to said neck such that said illuminating head is positionable at selected position with respect to said charging head; and
a light emitter coupled to said illuminating head, said light emitter emitting light such that said light emitter illuminates the area.

2. The assembly according to claim 1, wherein an oblique surface of an outer wall of said charging head extending between a top surface and a bottom surface of said outer wall of said charging head, said charging head being elongated between a first end and a second end of said charging head.

3. The assembly according to claim 1, wherein said neck having a bottom end and a top end, said neck being elongated between said top and bottom ends, said bottom end of said neck being coupled to a top surface of an outer wall of said charging head such that said neck is centrally positioned on said charging head.

4. The assembly according to claim 1, wherein an exterior wall of said neck being curvilinear such that said neck has a tubular shape, said exterior wall of said neck being laterally twisted such that said neck forms a helical coil extending between a bottom end and a top end of said neck.

5. The assembly according to claim 1, wherein said illuminating head having a lateral surface of an outermost wall of said illuminating head extending between each of a topmost surface and a bottommost surface of said outermost wall of said illuminating head, said illuminating head being elongated between a primary end and a secondary end of said illuminating head.

6. The assembly according to claim 1, wherein a rear side of a lateral surface of an outermost wall of said illuminating head being coupled to a top end of said neck.

7. The assembly according to claim 1, wherein said light emitter being coupled to a bottommost surface of an outermost wall of said illuminating head such that said light emitter selectively emits a beam of light away from said illuminating head.

8. The assembly according to claim 1, wherein said light emitter being one of a plurality of said light emitters, said plurality of light emitters being arranged in a plurality of columns and rows such that said plurality of light emitters is evenly distributed on a bottommost surface of an outermost wall of said illuminating head.

9. The assembly according to claim 1, wherein an actuator coupled to a top surface of an outer wall of said charging head.

10. The assembly according to claim 9, wherein said actuator being electrically coupled to a plurality of said light emitters such that said actuator selectively actuates and de-actuates said plurality of light emitters.

11. The assembly according to claim 1, wherein:
a power supply coupled to said charging head;
said power supply being electrically coupled to an actuator; and
said power supply comprising at least one rechargeable battery.

12. The assembly according to claim 1, wherein a base having a flanking surface of an extraneous wall of said base extending between a crowning surface and a basal surface of said extraneous wall of said base, said base being elongated between a leading end and a following end of said base.

13. The assembly according to claim 1, wherein a base being positionable on a support surface such that a basal surface of an extraneous wall of said base abuts the support surface.

14. The assembly according to claim 1, wherein a base being electrically coupled to a power source.

15. The assembly according to claim 1, wherein said charging head being positionable on a crowning surface of an extraneous wall of a base such that said charging head is electrically coupled to said base, said base re-charging a power supply in said charging head.

16. An illumination assembly configured to engage a support surface such that said illumination assembly is retained on the support surface, said illumination assembly providing hands free illumination of an area from a selected angle, said assembly comprising:
a charging head comprising an oblique surface of an outer wall of said charging head extending between a top surface and a bottom surface of said outer wall of said charging head, said charging head being elongated between a first end and a second end of said charging head.
a neck having a bottom end and a top end, said neck being elongated between said top and bottom ends, said bottom end of said neck being coupled to said top surface of said outer wall of said charging head such that said neck is centrally positioned on said charging head, an exterior wall of said neck being curvilinear such that said neck has a tubular shape, said exterior wall of said neck being laterally twisted such that said neck forms a helical coil extending between said bottom and top ends of said neck, said neck being flexible such that said neck is positionable at selected position with respect to said charging head;
an illuminating head having a lateral surface of an outermost wall of said illuminating head extending between each of a topmost surface and a bottommost surface of said outermost wall of said illuminating head, said illuminating head being elongated between a primary end and a secondary end of said illuminating head, a rear side of said lateral surface of said outermost wall of said illuminating head being coupled to said top end of said neck, said illuminating head being positionable at selected position with respect to said charging head;
a light emitter coupled to said bottommost surface of said outermost wall of said illuminating head such that said light emitter selectively emits a beam of light away from said illuminating head;
said light emitter being one of a plurality of said light emitters;
said plurality of light emitters being arranged in a plurality of columns and rows such that said plurality of light emitters is evenly distributed on said bottommost surface of said outermost wall of said illuminating head, said plurality of light emitters selectively illuminates the area;
an actuator coupled to said top surface of said outer wall of said charging head, said actuator being electrically coupled to said plurality of said light emitters such that said actuator selectively actuates and de-actuates said plurality of light emitters;
a power supply coupled to said charging head, said power supply being electrically coupled to an actuator, said power supply comprising at least one rechargeable battery; and
a base having a flanking surface of an extraneous wall of said base extending between a crowning surface and a basal surface of said extraneous wall of said base, said base being elongated between a leading end and a following end of said base, said base being positionable on a support surface such that a basal surface of an extraneous wall of said base abuts the support surface, said base being electrically coupled to a power source, said charging head being positionable on said crowning surface of said extraneous wall of said base such that said charging head is electrically coupled to said base, said base re-charging said power supply in said charging head.
